(19) United States
(12) Patent Application Publication
(10) Pub. No.: US 2004/0086211 A1
(43) Pub. Date: May 6, 2004

(54) Bearing/hub group with a sensor for vehicle wheels

(75) Inventors: Andreas Ruetter, Pinerolo (IT); Francesco Savarese, Airasca (IT)

Correspondence Address: MERCHANT & GOULD PC, P.O. BOX 2903, MINNEAPOLIS, MN, 55402-0903, US

(73) Assignee: SKF INDUSTRIE S.P.A, TORINO (IT)

(21) Appl. No.: 10/465,241

(22) Filed: Jun. 19, 2003

(30) Foreign Application Priority Data
Mar. 12, 2002 (IT) T02002A000205

(51) Int. Cl. F16C 41/04; F16C 32/00

(52) U.S. Cl. 384/448

(57) ABSTRACT

Bearing/hub group (1) with a sensor (8) for vehicle wheels, the group (1) presenting at least one rolling race which can revolve around a rotation axis A: a fixed rolling race (4) which is arranged outside the revolving rolling race (3) in a position which is coaxial to the revolving rolling race (3) itself and which is provided with a support flange (7) which projects towards the outside; and a sensor (8) which is mounted on the fixed revolving race (4) being made of different materials, and being connected to each other by an interface element (9) which is integral with the flange (7), and by two axial blocking elements (10) which are integral with the fixed rolling race (4) and which abut the interface element (9).

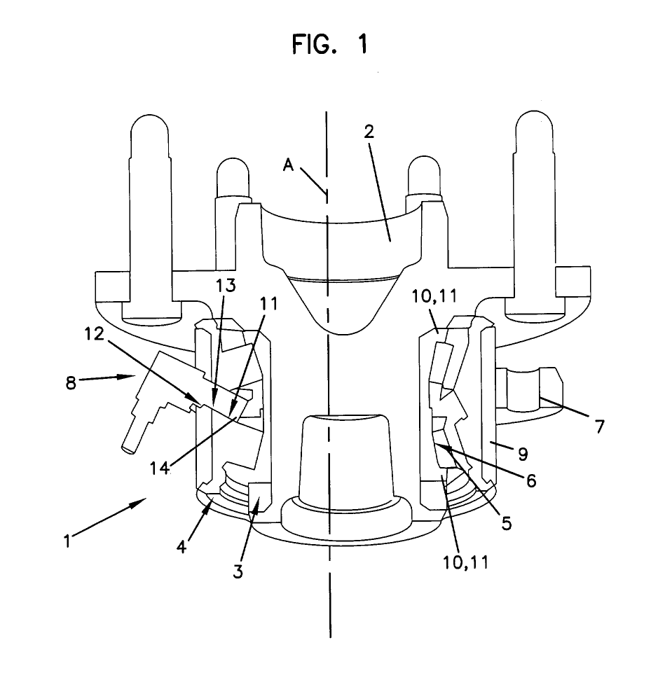

The present invention relates to a bearing/hub group with a sensor for vehicle wheels.

The U.S. Pat. No. 5,997,182 makes known a bearing/hub group with a sensor for vehicle wheels, the group comprising at least one rolling race which can rotate around a rotation axis; a fixed rolling race which is arranged outside the revolving rolling race in a position which is coaxial to the revolving rolling race itself and which is provided with a support flange which projects towards the outside; and a sensor which is mounted on the support flange.

In the group which has just been described above, both the rolling races and the support flange are made of the same material, for example high tensile steel, which results in the disadvantage that the manufacture of the group itself is not very cost-effective.

The aim of the present invention is to produce a bearing/hub group with a sensor for vehicle wheels, which will be devoid of the disadvantage described above.

According to the present invention, a bearing/hub group with a sensor for vehicle wheels will be produced, the group comprising at least one rolling race which can revolve around a rotation axis; a fixed rolling race which is arranged outside the revolving rolling race in a position which is coaxial to the revolving rolling race itself and which is provided with a flange which projects towards the outside; and a sensor which is mounted on the fixed rolling race; the group being characterised by the fact that the flange and the fixed rolling race are made of different materials, and they comprise connecting means for joining the flange to the fixed rolling race which are provided with an interface element which is integral with the flange, and two axial blocking elements which are integral with the fixed rolling race and which abut the interface element in order to render the flange and the fixed rolling race integral in relation to each other.

The invention will now be described with reference to the attached drawing which illustrate, in axial section, a non-limiting form of embodiment of the group which is described in the present invention.

With reference to the attached drawing, the number 1 indicates a bearing/hub group for vehicle wheels in its entirety.

The group 1 comprises a wheel hub 2 which can rotate around a rotation axis A, and a rolling race 3 which is integral with the hub 2 in order to rotate together with the hub 2 itself around the axis A. The group 1 also comprises a fixed rolling race 4 which is arranged outside the race 3 itself, and two series of rolling bodies 5 which are interposed between the two races 3 and 4, and which are suitable for rolling on two rolling tracks 6 for each series which are obtained on both the races 3 and 4 and which, for this reason, are made of high tensile steel, or other similar high quality materials.

In the example shown in the illustration, the race 3 is made of a single element on which two tracks 6 are obtained, but the race 3 could also be made of two different elements which are axially closed onto the hub 2 by means of a deck arrangement and which each present a relative track 6.

The group 1 also comprises a flange 7 which projects towards the outside of the race 4 in order to connect the group 1 itself to a support (which is not illustrated) of the vehicle, and a reading sensor 8 which is supported by the race 4, as will be better explained in the description which follows.

The flange 7 is made of a material which is different to the material of which the race 4 is made and it is not an integral part of the race 4 itself, thus, the group 1 comprises, finally, an interface cylinder 9 which is integral with the flange 7 itself and which is mounted on the race 4, and two blocking flaps 10 which are integral with the race 4 itself and which are arranged near the cylinder 9 in order to render the flange 7 and the race 4 integral in relation to each other.

In particular, the cylinder 9 is made of the same material as the flange 7 itself, either aluminium or cast iron, which results in obvious financial savings regarding the manufacture of the group 1, and the two flaps 10 are axially arranged on either side of the cylinder 9, and are produced by means of rolling the respective circumferential end edges 11a of the race 4 in such a way as to perfectly join the cylinder 9 and the race 4 to each other and thus impede that they make any axial or circumferential movement at all.

Both the race 4 and the cylinder 9 are provided with respective passing holes 11 and 12, which are aligned in relation to each other in a direction which is incident to the axis A, and which define a seat 13, which houses the sensor 8, and which is radially open towards the inside in a position which is substantially intermediate between the two rolling tracks 6 of the race 4.

The sensor 8 is defined by a cylindrical body 14, which is inserted, in such a way that it can be removed, inside the seat 13 and it is not subjected at all to any shearing stress as a result of the perfect connection between the cylinder 9 and the race 4 themselves. Furthermore, the central position of the sensor 8 also permits a reduction of the axial dimensions of the group 1 with a consequent reduction in the weight of the group 1 itself.

It is intended that the present invention should not be limited to the form of embodiment which is herein described and illustrated, which is to be considered as a form of embodiment of the bearing/hub group for vehicles with sensor, and which might be subject to further modifications with regard to the shape and arrangement of its parts, as well as to details pertaining to its construction and assembly.

1. Bearing/hub group (1) with a sensor (8) for vehicle wheels, the group (1) comprising at least one rolling race (3) which can revolve around a rotation axis (A); a fixed rolling race (4) which is arranged outside the revolving rolling race (3) in a position which is coaxial to the revolving rolling race (3) itself and which is provided with a flange (7) which projects towards the outside; and a sensor (8) which is mounted on the fixed rolling race (4); the group (1) being characterised by the fact that the flange (7) and the fixed rolling race (4) are made of different material, and they comprise connecting means (9, 10) for connecting the flange (7) to the fixed rolling race (4) which are provided with an interface element (9) which is integral with the flange (7), and two axial blocking elements (10) which are integral with the fixed rolling race (4) and which abut the interface element (9) in order to render the flange (7) and the fixed rolling race (4) integral in relation to each other.

2. Bearing/hub group according to claim 1, characterised by the fact that the interface element (9) is defined by a cylindrical race which is mounted on the fixed rolling race (4), and the two axial blocking elements (10) are produced by means of the plastic deformation of the respective end edges (11a) of the fixed rolling race (4) itself.

3. Bearing/hub group according to claim 2, characterised by the fact that the cylindrical race (9) and the fixed rolling race (4) are provided with a seat (13) for housing the said sensor (8); the seat (13) being defined by two passing holes (11, 12) which are aligned in relation to each other and which are obtained through the cylindrical race (9) and the fixed rolling race (4) themselves.

4. Bearing/hub group according to claim 3, characterised by the fact that the seat (13) faces the revolving rolling race (3) in a position which is substantially intermediate between the said two axial blocking elements (10).

5. Bearing/hub group according to claim 2, characterised by the fact that the said axial blocking elements (10) are produced by means of rolling the relative end borders (11a).
